(19) United States
(12) Patent Application Publication
(10) Pub. No.: US 2016/0242973 A1
(43) Pub. Date: Aug. 25, 2016

(54) Human Extraction Support System and Methods of Use

(71) Applicant: Emergency Services Group International, LLC, Ashburn, VA (US)

(72) Inventors: John Delaney, Ashburn, VA (US); Edward Reed Smith, JR., Leesburg, VA (US)

(21) Appl. No.: 15/047,261

(22) Filed: Feb. 18, 2016

Related U.S. Application Data
(60) Provisional application No. 62/117,502, filed on Feb. 18, 2015.

(51) Int. Cl. A61G 1/01; A61G 1/04; A61G 1/048; A61G 1/013; A61G 1/044

(52) U.S. Cl. CPC A61G 1/01; A61G 1/013; A61G 1/044; A61G 1/048; A61G 1/04

(57) ABSTRACT

The present invention provides a human extraction support system which is lightweight and can be stored in a pocket of a first responder, allows for field use to extract humans from combat casualty scenarios, and further provides the appropriate neck support to protect the head and cervical spine while maintaining airway patency. The human extraction support system, which includes at least a torso support system to connect the torso of a human to the human extraction support system and at least one strap connected to the torso support. Certain embodiments further include, a neck support system attached to the torso support for supporting the neck and cervical spine of the human, and a wrist support system attached to the torso support for positioning a human hands across their chest, neck support, or wrist support.

### CROSS-REFERENCE TO RELATED APPLICATIONS

The present application claims priority of U.S. Provisional patent application No. 62/117,502 filed Feb. 18, 2015, the contents of which are herein incorporated by reference.

### FIELD OF THE INVENTION

The present invention relates to devices for assisting in the transport of a human body, and more particularly, to a device for assisting first responders and military personnel to evacuate a human body from an area which conventional medical extraction devices may be prevented from accessing.

### BACKGROUND OF THE INVENTION

Evacuating humans from emergency zones to receive medical attention is a common occurrence both on the battlefield and for first responders. In many cases, it is difficult to provide access to larger equipment such as stretchers because of limitations such as terrain, surroundings, or in some cases, because of an on-going mass casualty scenario. In these cases, a human may often be injured or unconscious, thus preventing them from walking. Whether evacuating injured persons from a multi-story building during a fire, up a hill side in a car crash or battlefield scenario, or escape from within a crushed or nearly demolished structure, there remains an immediate need for a device to assist in evacuating an injured or unconscious person from a casualty setting to a remote location to receive medical assistance.

Several transfer devices for extracting and transporting such injured or unconscious persons currently exist. Many of these devices include mechanical lifts and/or slings that require multiple first responders to carry the injured person. Alternatively, trained operators with heavy mechanical equipment are needed. None of these solutions are suitable for an ongoing casualty setting or hard to reach accident scene.

Similarly, such emergency evacuation devices are typically heavy, rigid devices that are difficult to use in emergency situations, particularly by untrained personnel. They are rarely available when needed due to their size and the difficulty in storing such devices. Thus, there is a need in the art for a person transfer, immobilizer, and carrier device that is lightweight can be used by unskilled operators or by people who work in public safety such as: police; fireman; tactical; homeland security; EMS units; Military personnel; Private Security Contractors or anyone with the need to easily and quickly lift, move, immobilize, and transport a person whom has fallen, conscious or unconscious, wounded in the line of fire, for a quick evacuation to get someone to safety.

Other drag straps require the use of vest or other equipment typically worn by a professional first responder, but does not account for civilians in an emergency response. Other transfer and emergency evacuation devices also fail to adequately secure a person being transported in the device. It is important to secure the arms when moving a patient as it lowers the width of the patient allowing easier movement from place to place; however no human evacuation device to date incorporates a biomechanically sound method that would also help distribute the pulling force to extract the person. Some devices exist that would allow for the detainment of a person's hands behind their back, however this technique is not biomechanically sound, would cause additional injury to the person if a pulling force is exerted on the arms, and is generally used only if a person is to be detained. To date no drag strap provides for straps that allow for the correct positioning of the arms and hands of the patient.

It is also important for the health and welfare of an injured person to provide appropriate neck support. Such support prevents the patient's head and neck from striking the ground as well as protects the cervical spine and airway patency by holding the head in a neutral position and preventing hyperextending during movement. Thus there remains an unmet need to provide such an extraction device that also includes neck support for an extracted patient.

Additionally, it should be appreciated that the size, weight and shape of an injured person is typically unknown, and it is not feasible for a first responder to carry several pieces of equipment to accommodate persons of varying size. Thus there exists a need for an evacuation device which can be operated by a single person and which includes adjustments such that a single device can be adjusted at the scene of an emergency to fit almost any sized person.

Finally, it should be appreciated that depending on the build of the first responder, and the particular terrain of the emergency or mass casualty, that a fixed length strap for carrying an injured person is limited. Thus there further exists a need for an evacuation device which includes adjustable length handles to account for different size rescuers and different terrain and which can be operated by a single person.

No extraction device has been offered to date to account for any of these shortcomings, thus there remains an unmet need for an extraction device that is lightweight, which allows for the correct positioning of the arms and hands of the person, which includes a neck support to protect the head and cervical spine while maintaining airway patency, which is adjustable to fit just about any sized human, and can be operated by a single person for the transport of one or more humans.

### SUMMARY OF INVENTION

In order to address the unmet needs defined above, the present invention provides a human extraction support system, which includes a torso support system for supporting the torso of a human, and at least one handle strap connected to the torso support system. The system is lightweight and can be stored in a pocket of a first responder. In addition the at least one handle strap can be routed behind the neck and head of the human being extracted to provide the appropriate neck support to protect the head and cervical spine while maintaining airway patency. To minimize the human's arms from unnecessarily dragging or being snagged, in some embodiments the torso support system further includes a wrist support system for retaining the arms of the human across their chest. Finally, in at least one embodiment, the present invention further includes a neck support system for supporting the neck of a human when connected to the torso support system.

The present invention further provides a human extraction support system, which includes a torso support system to connect the torso of a human to the human extraction support system, a neck support system attached to the torso support for supporting the neck and cervical spine of the human, a wrist support system attached to the torso support for positioning a human hands across their chest, and at least one strap connected to the torso support, neck support, or wrist support, the at least one strap further comprising a handle. Such inventive human extraction support system allows for the torso support to connect across the chest of the human, with the wrist support system securing the humans wrists across the humans chest, and the neck support system providing support to the cervical spine upon the at least one handle strap being engaged for pulling the human body for evacuation.

### BRIEF DESCRIPTION OF THE DRAWINGS

FIG. 1 provides an overhead view of the 100 human extraction support system, illustrating the 200 torso support system, the 300 at least one handle strap with 301 handle strap adjustments and a 302 loop forming a handle, the 400 neck support system having 401 at least two fabric support straps interconnected by a 402 neck support fabric and the 500 wrist support system with at least one 501 wrist strap.

FIGS. 2A-2B illustrate a blown up view of the 200 torso support system and the 500 wrist support system. The 200 torso support system includes a 201 torso support fastener at each of its ends for fastening a person into the 200 torso support system. FIG. 2A further illustrates a 501 wrist strap and a 502 wrist support fastener, while FIG. 2B further illustrates that the 500 wrist support system is adjustable laterally about the 200 torso support system, that is limited by a 503 fabric loop to accommodate for those persons with varying arm lengths.

FIG. 3 provides an overhead view of one embodiment of the 100 human extraction support system, illustrating the 200 torso support system, the 300 at least one handle strap with 301 handle strap adjustments and a 303 handle grip, the 400 neck support system and the 500 wrist support system.

FIG. 4 is a perspective view of the 100 human extraction support system when folded for storage illustrating the ease for the system to be carried or stored on the person of a first responder.

FIG. 5 is a perspective view of the 100 human extraction support system when in use, showing the wrist of the human being extracted being connected to the 500 wrist support system, the 200 torso support system being connected across the chest of the human to engage under the armpits of the human, the neck and spine of the patient being supported by the 400 neck support system, and the human being extracted by emergency responders through the use of the 300 at least one handle strap.

### DETAILED DESCRIPTION OF THE INVENTION

The following detailed description is merely exemplary in nature and is in no way intended to limit the scope of the invention, its application, or uses, which may vary. The invention is described with relation to the non-limiting definitions and terminology included herein. These definitions and terminology are not designed to function as a limitation on the scope or practice of the invention, but are presented for illustrative and descriptive purposes only.

Various terms used throughout the specification and claims are defined as set forth below as it may be helpful to an understanding of the invention.

The present invention contains the features of a human extraction support system as herein described.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

### General

The present invention provides for a human extraction support system which includes a torso support system for supporting the torso of a human and at least one handle strap connected to the torso support system. The human extraction support system is used to connect around the chest of a human body by the torso support system and at least one handle strap is included to allow for the transport of a human body as a result of the connection of the torso support system to the human body. While the torso support system fastens around the back, under the arms and buckles in the front of the chest, the at least one handle strap is routed underneath the armpit and across the back of the shoulder when in use. This allows a first responder to remove an injured or unconscious human from an area similar to a one-man drag procedure that is relatively well known in the art. The human extraction support system is a simple device that is secured to a patient, victim or anyone who needs to be moved to a different location.

In at least one embodiment, the human extraction support system further includes a wrist support system attached to the torso support for positioning a human hands across a patient's chest.

In at least one embodiment the inventive human extraction support system may further include a neck support system attached to the torso support for supporting the neck and cervical spine of the human; or a leg support system which may be used for a two-man carry or to assist in lifting a human body to a bed, gurney or to an evacuation vehicle. In at least one embodiment, a torso support system is included with a neck support system and a wrist support system, where a human body is connected to the torso support across the chest of the human, the wrist support system secures the humans wrists across the humans chest, and the neck support system provides support to the cervical spine upon the at least one handle strap being engaged by a first responder or a mechanical device to pull the human body for evacuation. It should be understood that when the inventive human extraction support system is used, it is intended to assist a single first responder to remove an unconscious or injured human from an area to a secure area for medical evaluation or treatment. When used properly, it is intended that the torso of the human is slightly upright while the feet are to be dragged on the ground.

The inventive human extraction support system is intended to be lightweight for ease of carrying on the person or with regular equipment of a first responder or combat personnel without adding additional burden to the first-responder or combat personnel. In at least one embodiment, the human extraction support system weights under three pounds and compacts to the size of a cellular phone. In at least one embodiment, the human extraction support system, when folded, is carried in a small carrying case or is stored within the pocket of a first responder or combat personnel.

### Torso Support System

The central component of the inventive human extraction support system is the torso support system. The torso support system is a belt or strap which fastens around an injured or unconscious human. In at least one embodiment the torso support system includes at least one fabric torso support having a first end and a second end that is tied or fastened together. In at least one embodiment, the at least one fabric torso support further includes a torso fastening mechanism to connect the first end and the second end of the at least one fabric torso support. In at least one embodiment, the torso fastening mechanism is adjustable to reduce or increase the size of the at least one fabric torso support in order to accommodate for larger or smaller chests for different patients. It should be appreciated that many types of fasteners are known in the art, and nothing herein should limit the torso fastening mechanism to any particular fastening mechanism. In at least one embodiment it is intended that the torso support system is to be completely adjustable to enable the system to secure to the smallest person or very large person that a first-responder or combat medic can be expected to encounter. In at least one embodiment the torso support system may be unfastened and routed like a belt around any equipment or clothing that may be worn by a person. In at least one embodiment the torso support system is buckled together on the front side of a patient. In at least one embodiment, the torso support system further includes a wrist support system.

### Wrist Support System

A wrist support system serves at least two purposes: first, it prevents the arms from moving outside the core of the patient and second, when being pulled by a rescuer or another person. Conventionally wrists are preferred to be secured such that when the human evacuation device is engaged, that the pulling of the handle straps upward locks the wrists and arms into a favorable position for applying traction to the body. It should be appreciated that the arm and wrist position is a particular concern when patients who are being moved are unconscious or unable to follow directions.

In at least one embodiment of the human extraction support system a wrist support system is provided. It should be appreciated that where extracting a human body from a casualty scene with narrow passages, corridors, or otherwise cluttered terrain, that it may be necessary to prevent the injured or unconscious persons arms from flopping, dragging, or moving outside the core of the body. It should further be appreciated that when an injured or unconscious patient is being pulled, that it is desirable to position the arms and wrists into a biomechanically sound position to exert the pulling force similar to a standing one-man rescue that is routinely used in the art. Moreover, it is also important to secure the arms when moving a patient as it lowers the width of the patient allowing easier movement from place to place.

In at least one embodiment the wrist support system includes two attachment points where the wrists of the patient are secured. This may include wrist loops or wrist straps. In at least one embodiment, a patient's wrists are placed within the wrist support system and the wrist support system is tightened to prevent removal of the wrists from the wrist support system. In at least one embodiment the wrist support system is attached to the chest strap. In at least one embodiment, the wrist support system is adjustable so as to fit all sizes of individuals.

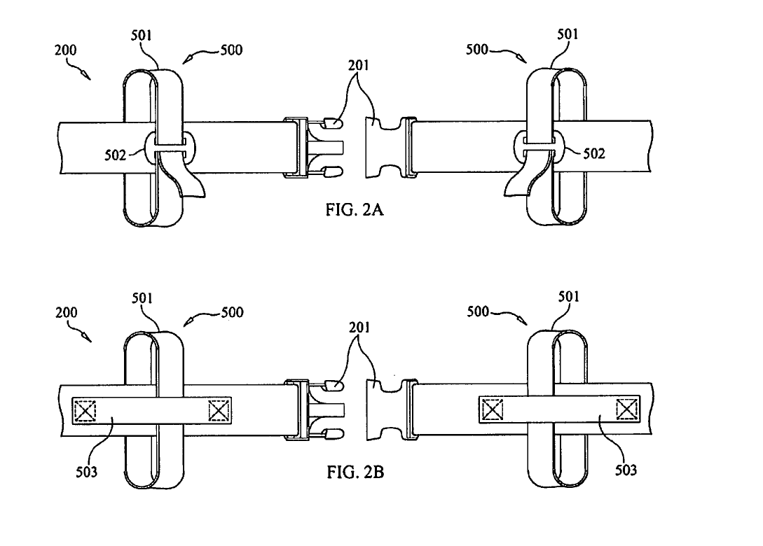

In at least one embodiment, the wrist support system further includes at least one wrist strap attached to the torso support system. In at least one embodiment, the wrist support system further comprises of at least one wrist strap that is moveable along the torso support system to accommodate for different size human bodies. In at least one embodiment the wrist strap is moveable within a loop that is connected on the inside of the torso support system. In at least one embodiment, the loop for moving the wrist strap is at least one (1) inch in length. In at least one embodiment, the loop for moving the wrist strap is twelve (12) inches in length. At least one embodiment of the moveable wrist strap is illustrated in FIG. 2B.

In at least one embodiment, the wrist support system includes at least one wrist strap having a first end and a second end and further includes a fastening mechanism to connect the first end and the second end of the at least one wrist strap. In at least one embodiment the fastening mechanism is adjustable to reduce or increase the size of the wrist strap in order to accommodate for larger or smaller wrists. Without limiting the invention, it should be appreciated that many types of fasteners for belts or straps are well known in the art, and nothing herein should limit the invention to any particular fastening mechanism.

### Neck Support System

It is a further goal of this invention to further provide a system which supports the head of a patient from hitting the ground as the patient is being moved, while protecting the cervical spine and airway patency by holding the head in a neutral position and preventing hyperextending during movement. In at least one embodiment, the inventive human extraction support system includes a neck support system for supporting the neck of a human. In at least one embodiment, the neck support system is connected to the torso support system.

It is appreciated that when a human body is connected to the torso support system and that the at least one handle strap is being pulled that the neck support system provides support to the cervical spine and back and the at least one handle strap allow for the transport of a human body. In at least one embodiment the neck support system includes at least two fabric neck supports interconnected by at least one fabric for supporting a human neck. In at least one embodiment the at least two fabric neck supports are part of the handle straps. In at least one embodiment the at least one handle straps connect to the at least two fabric neck supports. In at least one embodiment, the two fabric neck supports are connected laterally at one end by the torso support system, and connected laterally at the opposite end by a lateral neck support strap. In at least one embodiment, the handle straps are connected to the lateral neck support strap. It is appreciated that in at least one embodiment that fabric neck supports extend at angles from the backside of the torso support system in two primary locations on either side of the back. In at least one embodiment, the fabric neck supports continue to a point well past the head and end with attachment buckles for connecting at least one handle strap.

It is desirable to include lightweight webbing or mesh between the fabric neck supports to provide the desired support for the neck and cervical spine. In at least one embodiment the fabric neck supports are connected by at least one fabric. In at least one embodiment the at least one fabric is a series of straps, a webbed material, a netting material, or combinations thereof connected between the at least two fabric neck supports. It should be appreciated that the at least one fabric should be sufficient to support the weight of the shoulders, neck and head of an injured or unconscious person. In at least one embodiment, the at least one fabric has a breaking strength of at least three hundred (300) pounds.

### Handle Straps

At least one handle strap is included as part of the human extraction support system to allow a mechanism for a person or piece of equipment to engage or pull the human extraction support system when extracting an unconscious or injured person when connected to the system. In at least one embodiment the at least one handle strap connects to the torso support system. In at least one embodiment, the at least one handle strap connects to the neck support system. In at least one embodiment the at least one handle strap is a plurality of handle straps connected to the neck support system of the torso support system, or combinations thereof.

In at least one embodiment the at least one handle strap includes two pieces of webbing with both pieces ending in a loop forming a handle. In at least one embodiment the length of the handle strap is adjustable. In at last one embodiment the at least one handle strap is connected and adjusted through an attachment buckle on the handle strap to allow both for alternate handles and to allow the rescuer to adjust the length of the overall traction strap and handle assembly. It is appreciated that differing lengths allow the rescuer to create different angles of force while moving the patient to account for differing friction and terrain surfaces and the physical attributes of the rescuer.

In at least one embodiment the human extraction support system includes two handle straps. In this embodiment, the handle straps include loops at one end for grabbing and pulling by the rescuer. In this embodiment, the other end is attached by a buckle to the fabric neck supports. This connection allows the handle strap to be adjustable in length to change the distance the rescuer is from the patient during pulling as well as the angle of force. It is appreciated that the length of the traction-handle assembly and the required angle of force to move a patient is dependent on a number of factors to include the size of the rescuer, length of the arms of the rescuer, size of the patient, type of terrain, etc.

In at least one embodiment a handle is connected to the handle strap or is within the loop of the handle strap. In at least one embodiment the handle includes a grip. In at least one embodiment the handle or grip is made from rubber, leather, plastic, silicone, poly vinyl chloride (PVC), or combinations thereof.

It is intended that the handle straps are to be carried by a first responder or combat personnel to evacuate the injured or unconscious person from an unsafe or undesirable area. In at least one embodiment, a hoist or pulley system may be used to assist in pulling an injured or unconscious person from an emergency area. In at least one embodiment, the handle straps may be connected to a karabiner worn on a first responder or combat personnel.

### Leg Support System

In some embodiments, it may be desirable to additionally include a method to allow for first responders to hoist an injured or unconscious patient to other medical equipment such as a stretcher or gurney, or it may be necessary to hoist the patient into an extraction vehicle. In at least one embodiment of the human extraction support system at least one additional handle strap extends from the torso support system, opposite of the neck support system, to form a leg support system. In at least one embodiment the leg support system is routed from the torso support system, across the thigh, and under the leg to support the hamstring of the patient.

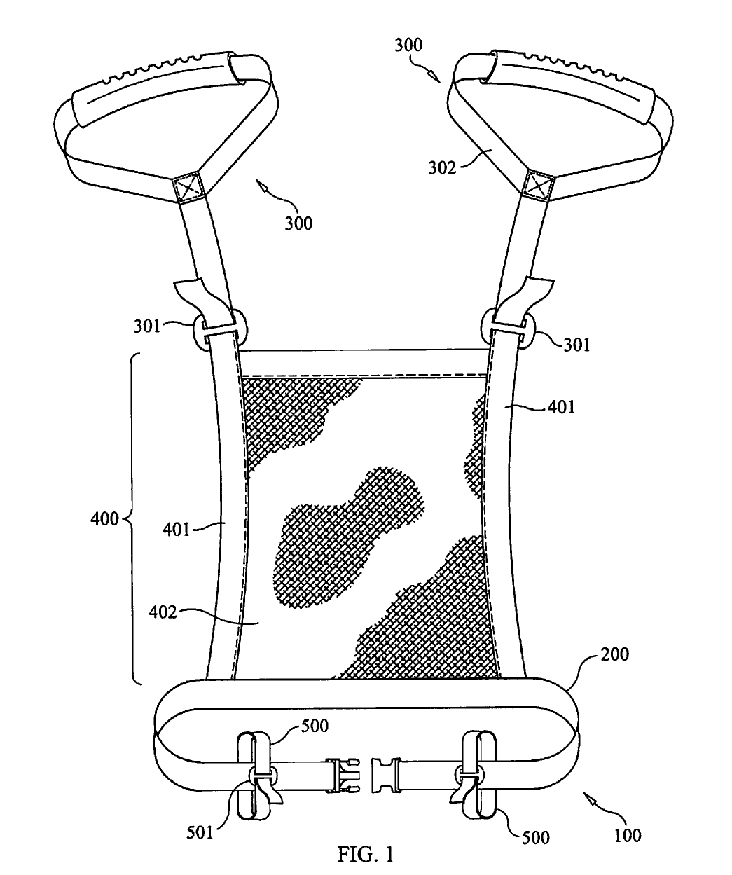

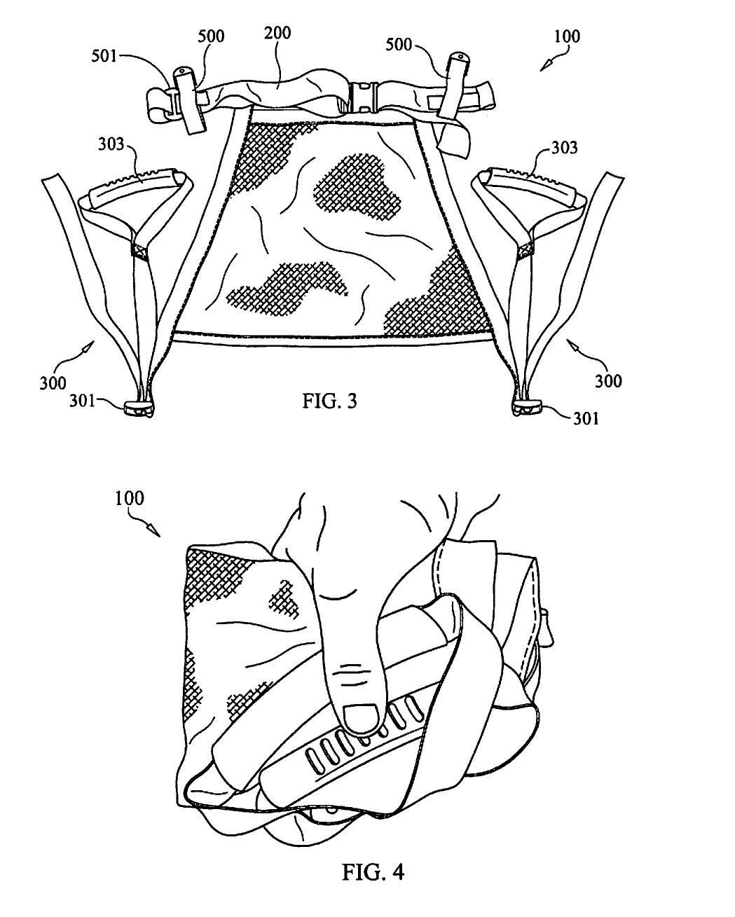

The drawings and diagrams shown herein depict example arrangements of elements of the system and method. More or less than all the features available or contemplated may be present in an actual embodiment. It should also be understood that FIGS. 1-4 are merely illustrative and may not be drawn to scale.

### EXAMPLES

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

### Example 1

A 100 human extraction support system is provided and illustrated in FIGS. 1-4. The 100 human extraction support system includes a 200 torso support system, an 300 at least one handle strap with 301 handle strap adjustments, a 400 neck support system and the 500 wrist support system with at least one 501 wrist strap. The 200 torso support system includes a 201 torso support fastener at each of its ends for fastening a person into the 200 torso support system. A 501 wrist strap and a 502 wrist support fastener is also provided that is adjustable laterally about the 200 torso support system, which adjustment is limited by a 503 fabric loop to accommodate for those persons with varying arm lengths.

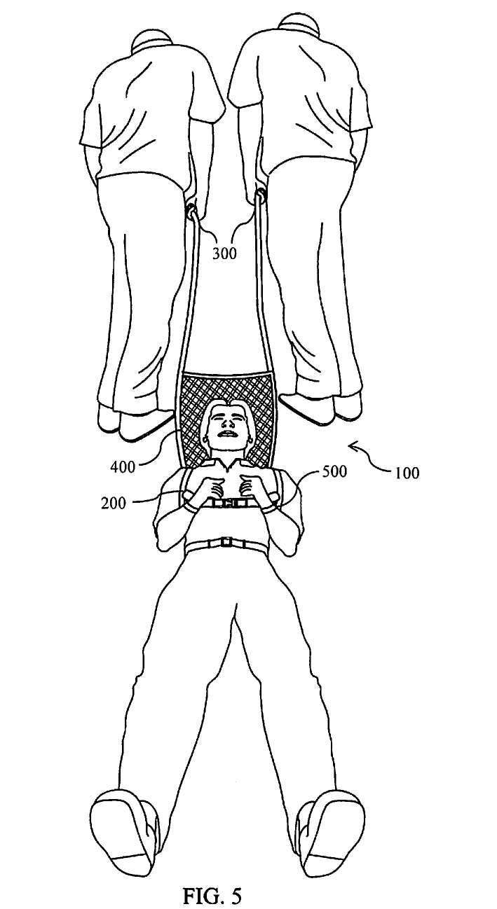

A first responder responds to the scene of a combat casualty scenario where an injured and unconscious human rests. The first responder removes the 100 human extraction support system from a pocket of the first responders gear, and unfolds the 100 system. The first responder unfastens the 200 torso support system by disconnecting the 201 fastening mechanism and repositions the patient over the 100 human extraction support system. The first responder fastens the 200 torso support system using the 201 fastening mechanism across the chest of the patient and follows by adjusting and securing the wrists of the patient to the 501 wrist straps of the 500 wrist support system. This is done by first repositioning the 501 wrist straps within the 503 fabric loops to accommodate for the injured patients arm length, then by connecting and adjusting the length of the 502 wrist strap fastening mechanism. The first responder adjusts the 301 handle strap adjustments to accommodate for the first responders arm length, and lifts the 300 handle straps by the 302 handle grips to remove the patient. When lifted the 300 handle straps engage the 400 neck support system. The 401 at least two fabric neck supports are interconnected by 402 at least one fabric for supporting a human neck, such that when the 300 handle straps are engaged, that the 400 neck support system provides support to the neck and cervical spine. FIG. 5 illustrates a human being connected to the 100 human extraction support system as herein described. The first responder drags the injured patient, whose feet remain dragging on the ground during transport, to a safe and secure location so that the first responder may administer the necessary medical attention to the injured patient.

### Other Embodiments

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

1. A human extraction support system, the system comprising:
a torso support system for supporting the torso of a human;
at least one handle strap connected to said torso support system;
wherein a human body is connected to said torso support and said at least one handle strap allow for the transport of a human body as a result of the connection of the torso support system to the human body.

2. The system of claim 1, wherein said torso support system further comprises at least one fabric torso support having a first end and a second end for supporting a human torso.

3. The system of claim 1, wherein said at least one fabric torso support further comprises a torso fastening mechanism to connect the first end and the second end of the at least one fabric torso support.

4. The system of claim 3 wherein said torso fastening mechanism is adjustable to reduce or increase the size of at least one fabric torso support in order to accommodate for larger or smaller chests.

5. The system of claim 1, wherein said torso support system further comprises a wrist support system.

6. The system of claim 5, wherein said wrist support system further comprises of at least one wrist strap attached to the torso support system.

7. The system of claim 5 wherein said wrist support system further comprises of at least one wrist strap that is moveable along the torso support system to accommodate for different size human bodies.

8. The system of claim 5 wherein said wrist support system further comprises of at least one wrist strap having a first end and a second end, a fastening mechanism to connect the first end and the second end of the at least one wrist strap.

9. The system of claim 8 wherein said fastening mechanism is adjustable to reduce or increase the size of the wrist strap in order to accommodate for larger or smaller wrists.

10. The system of claim 1 further comprising a neck support system for supporting the neck of a human when connected to the torso support system, wherein a human body is connected to said torso support, said neck support system provides support to the cervical spine and back and said at least one handle strap allow for the transport of a human body.

11. The system of claim 10 wherein said neck support system further comprises at least two fabric neck supports interconnected by at least one fabric for supporting a human neck.

12. The system of claim 11 wherein said at least one fabric is a series of straps, a webbed material, a netting material, or combinations thereof connected between the at least two fabric neck supports.

13. The system of claim 9 wherein said neck support system is attached to said torso support system.

14. The system of claim 1, wherein said handle strap, said fabric torso support, or said fabric neck support is made from nylon, kevlar, cotton, polyester, steel, elastic, neoprene, other woven materials, or combinations thereof.

15. A human extraction support system, the system comprising:
a torso support system for holding the torso of a human;
a neck support system attached to said torso support for supporting the neck and cervical spine of the human;
a wrist support system attached to said torso support for positioning a human hands across their chest; and
at least one strap connected to said torso support, neck support, or wrist support, said at least one strap further comprising a handle;
wherein a human body is connected to said torso support across the chest of the human, said wrist support system secures the humans wrists across the humans chest, and said neck support system provides support to the cervical spine upon said at least one handle strap being engaged for pulling the human body for evacuation.

16. The system of claim 15 further comprising a plurality of straps comprising handles.

17. The system of claim 16 wherein said strap comprising a handle further comprises of a grip, said grip made from rubber, leather, plastic, silicone, poly vinyl chloride (PVC), or combinations thereof.

18. The system of claim 16 wherein at least one additional strap comprising a handle extends from the torso support system, opposite of the neck support system, to form a leg support system.

19. The system of claim 18 wherein said leg support system is routed from the torso support system, across the thigh, and under the leg to support the hamstring of the human.

20. A human extraction support system, the system comprising:
a wrist support system attached to said torso support for positioning a human hands across their chest.

21. The system of claim 20 wherein said wrist support system further comprises of at least one wrist strap that is moveable along the torso support system to accommodate for different size human bodies.

22. The system of claim 20 wherein said wrist support system further comprises of at least one wrist strap having a first end and a second end, a fastening mechanism to connect the first end and the second end of the at least one wrist strap.

23. The system of claim 20 further comprising:
a torso support system for holding the torso of a human;
a neck support system attached to said torso support for supporting the neck and cervical spine of the human; and
at least one strap connected to said torso support, neck support, or wrist support, said at least one strap further comprising a handle.
